(19) United States
(12) Patent Application Publication
(10) Pub. No.: US 2010/0255407 A1
(43) Pub. Date: Oct. 7, 2010

(54) ELECTRODE, METHOD OF PREPARING THE SAME, AND FUEL CELL INCLUDING THE SAME

(75) Inventors: Tae-young Kim, Seoul (KR); Duck-young Yoo, Seoul (KR); Suk-gl Hong, Suwon-si (KR)

Correspondence Address: STEIN MCEWEN, LLP, 1400 EYE STREET, NW, SUITE 300, WASHINGTON, DC, 20005, US

(73) Assignee: Samsung Electronics Co. Ltd., Suwon-si (KR)

(21) Appl. No.: 12/636,996

(22) Filed: Dec. 14, 2009

(30) Foreign Application Priority Data
Apr. 1, 2009 (KR) 10-2009-0028146

(51) Int. Cl. H01M 8/10; H01M 4/86; H01M 4/88

(52) U.S. Cl. 429/494; 502/101; 429/535

(57) ABSTRACT

An electrode, a membrane-electrode assembly including the electrode, a fuel cell including the membrane-electrode assembly, and a method of making the same, the electrode including a gas diffusion layer, a catalyst layer, and a water-repellent material having a concentration gradient, disposed at an interface between the gas diffusion layer and the catalyst layer. The water-repellent material may be disposed in a dot pattern.

### CROSS-REFERENCE TO RELATED APPLICATION

This application claims the benefit of Korean Patent Application No. 10-2009-0028146, filed on Apr. 1, 2009, in the Korean Intellectual Property Office, the disclosure of which is incorporated herein, by reference.

### BACKGROUND

1. Field

One or more embodiments of the present teachings relate to an electrode, a method of manufacturing the electrode, a membrane-electrode assembly (MEA) including the electrode, and a fuel cell including the MEA.

2. Description of the Related Art

Polymer electrolyte membrane fuel cells (PEMFCs) can include a phosphoric acid-impregnated electrolyte membrane, to operate in high-temperature, non-humidified conditions. In such PEMFCs, phosphoric acid migrates into an electrode from the electrolyte membrane and operates as a proton conductor in the electrode. Thus, the amount and permeation rate of phosphoric acid into the electrode and the distribution of phosphoric acid affect the utilization ratio of a catalyst layer, and the performance of the electrode. Phosphoric acid inherently has a low oxygen solubility and a low diffusion coefficient and thus, suppresses the supply of oxygen from an air electrode (cathode) to the catalyst.

Thus, phosphoric acid should be uniformly distributed over the catalyst layer, to facilitate proton conduction. In addition, the phosphoric acid should not block an oxidant path, so that an oxidant may flow smoothly into the catalyst layer.

For these reasons, a water-repellent material having a concentration gradient is used in the catalyst layer of electrodes. In other words, a catalyst layer should have a less hydrophobic side disposed closest to the electrolyte membrane, through which phosphoric acid flows, and a more hydrophobic side disposed closest to a gas diffusion layer, through which an oxidant flows.

For an electrode of a low-temperature PEMFC, a water-repellent material may be further added to control moisture content. In this case, a slurry containing the water-repellent material may be prepared and coated on a catalyst layer of an electrode. Thus, the water-repellent material is distributed uniformly within the catalyst layer. However, it may be difficult to control the concentration gradient of the water-repellent material in the electrode. To address this problem, it has been suggested to coat at least two catalyst layers, using at least two catalyst slurries having different concentrations of a water-repellent material, such that the water-repellent material has a discontinuous concentration gradient.

According to Japanese Patent Publication No. 2008-60002, two catalyst slurries have different concentrations of a water-repellent material coated thereon, so that the concentration of the water-repellent material is higher on a side of the catalyst layer that contacts an electrolyte membrane, in order to block the migration of water. Thus, the deterioration caused by the deposition of a catalytic metal in the electrolyte membrane is prevented. When two catalyst layers are formed using such catalyst slurries, the distribution of the water-repellent material may vary sharply at the boundary of the two catalyst layers. In addition, the concentration gradient of the water-repellent material may hinder the uniform distribution of phosphoric acid into catalyst layers and may hinder the migration of oxygen.

According to US Patent Publication No. 2005/0106450 A1, a catalyst slurry is coated multiple layers, having various concentrations of a water-repellent material and different porosities, to provide a fine concentration gradient. The multiple layers provide for a finer concentration gradient. However, each additional catalyst layer decreases the diffusion rate of a gas there through, so that the number of layers is generally limited to 3 to 8 layers. In this case, the water-repellent material has a concentration gradient in the thickness direction of the electrode, but has a uniform distribution along the x-y surface (surface direction) of the catalyst layer.

### SUMMARY

One or more embodiments of the present teachings include an electrode having a water-repellent material having concentration gradients, with respect to thickness and surface directions of the electrode.

One or more embodiments of the present teachings include a method of manufacturing the electrode.

One or more embodiments of the present teachings include a membrane-electrode assembly (MEA) including the electrode.

One or more embodiments of the present teachings include a full cell including the MEA.

According to one or more embodiments of the present teachings, an electrode includes: a gas diffusion layer; a catalyst layer; and a water-repellent material that is distributed at an interface between the gas diffusion layer and the catalyst layer, the water-repellent material having a continuous concentration gradient in a thickness direction and a discontinuous concentration gradient in a surface direction.

According to one or more embodiments of the present teachings, the amount of the water-repellent material may be in a range of about 0.01 mg/cm² to about 0.1 mg/cm², with respect to the gas diffusion layer.

According to one or more embodiments of the present teachings, the water-repellent material have a concentration gradient at the interface between the gas diffusion layer and the catalyst layer that continuously decreases from the gas diffusion layer to the catalyst layer.

According to one or more embodiments of the present teachings, the water-repellent material may include a hydrophobic polymer.

According to one or more embodiments of the present teachings, a method of manufacturing an electrode includes: applying a water-repellent material on a first surface of a gas diffusion layer, in a dot pattern; coating a catalyst slurry on the first surface of the gas diffusion layer, to form a catalyst layer; and thermally treating the resultant.

According to one or more embodiments of the present teachings, the water-repellent material may be applied using a micro-dispenser, a screen printer, or a template.

According to one or more embodiments of the present teachings, the thermally treating may be performed at a temperature of from about 300 to about 400° C., for from about 10 to about 90 minutes.

According to one or more embodiments of the present teachings, a membrane-electrode assembly includes a cathode, an anode, and a polymer electrolyte membrane, with at least one of the cathode and the anode being the electrode described above.

According to one or more embodiments of the present teachings, a fuel cell includes the membrane-electrode assembly.

### BRIEF DESCRIPTION OF THE DRAWINGS

These and/or other aspects will become apparent and more readily appreciated from the following description of the exemplary embodiments, taken in conjunction with the accompanying drawings, of which:

FIG. 1 schematically illustrates a conventional method of manufacturing an electrode having a concentration gradient of a water-repellent material;

FIG. 2 schematically illustrates a method of manufacturing an electrode having a concentration gradient of a water-repellent material, according to an exemplary embodiment of the present teachings;

FIG. 3 is a graph of voltage with respect to current density of membrane-electrode assemblies (MEAs) according to Example 1 and Comparative Examples 1 and 2;

FIGS. 4A and 4B are a scanning electron microscopic (SEM) image and an electron probe microanalytic (EPMA) image, respectively, of an MEA according to Example 2; and

FIG. 5 is a SEM image of the electrode according to Example 2.

### DETAILED DESCRIPTION

One or more exemplary embodiments of the present teachings provide an electrode including a gas diffusion layer, a catalyst layer, and a water-repellent (hydrophobic) material disposed at an interface between the gas diffusion layer and the catalyst layer. The water-repellant material may have a continuous concentration gradient in a thickness direction and a discontinuous concentration gradient in a surface direction.

According to an exemplary embodiment, the water-repellent material may have concentration gradients both in the thickness direction (z-direction) and a surface direction (x-y direction), unlike existing electrodes that have a water-repellent material that is uniformly distributed, is distributed in a step-wise concentration gradient, or is distributed in a continuous concentration gradient in the thickness direction and a uniform concentration in the surface direction. In other words, the water-repellent material may have a concentration gradient at the interface between the gas diffusion layer and the catalyst layer, the concentration of the water-repellent material continuously decreasing from the gas diffusion layer toward the catalyst layer. In addition, the water-repellent material may have a discontinuous concentration gradient at the interface between the gas diffusion layer and the catalyst layer, in the surface direction. In other words, the water-repellent material may be arranged in dots that have a radial concentration gradient, in the surface direction. The concentration gradient of the water-repellent material in the surface direction may be in the form of a regular or irregular wave-formed concentration gradient. The amount of the distributed water-repellent material may be in a range of about 0.01 mg/cm² to about 0.1 mg/cm², with respect to the gas diffusion layer.

Examples of the water-repellent material include hydrophobic polymers, such as Teflon-based polymers including polytetrafluoroethylene (PTFE), fluorinated ethylene propylene (FEP), perfluoroalkoxy (PFA), Cytop (available from Asahi Glass Co., Ltd.), or the like.

The catalyst layer may be formed of particles of, for example, platinum (Pt), ruthenium (Ru), tin (Sn), palladium (Pd), titanium (Ti), vanadium (V), chromium (Cr), manganese (Mn), iron (Fe), cobalt (Co), nickel (Ni), copper (Cu), zinc (Zn), aluminum (Al), molybdenum (Mo), selenium (Se), tungsten (W), iridium (Ir), osmium (Os), rhodium (Rh), niobium (Nb), tantalium (Ta), lead (Pb), or mixtures or alloys thereof. Nano-sized Pt and an alloy thereof may be used, for example. In particular, the cathode may include Pt or a Pt alloy catalyst, such as Pt/C, PtCo/C, or PtCr/C, and the anode may include Pt or a Pt alloy catalyst such as Pt/C or PtRu/C.

The catalyst layer may further contain a binder to increase adhesiveness of the catalyst layer and to facilitate migration of protons. The binder may be a proton-conducting polymer resin, for example, a polymer resin having a cation exchange group side chain, the cation exchange group being selected from the group consisting of a sulfonic acid group, a carboxylic acid group, a phosphoric acid group, a phosphonic acid group, and derivatives thereof. For example, the proton-conducting polymer resin may include at least one proton-conducting polymer selected from the group consisting of a fluorine polymer, a benzimidazol polymer, a polyimide polymer, a polyetherimide polymer, a polyphenylenesulfide polymer, a polysulfone polymer, a polyethersulfone polymer, a polyetherketone polymer, a polyether-etherketone polymer, and a polyphenylquinoxaline polymer.

The gas diffusion layer may include a substrate and a microporous layer. The substrate may be a conductive substrate. Examples of a conductive substrate include, but not limited to, a carbon paper, a carbon cloth, a carbon felt, or a metal cloth. In general, the microporous layer may contain a conductive powder having a small diameter, for example, carbon powder, carbon black, acetylene black, activated carbon, carbon fibers, fullerenes, carbon nanotubes, carbon nanowires, carbon nanohorns, or carbon nanorings. The gas diffusion layer may be a commercially available product. Alternatively, the gas diffusion layer may be prepared by directly coating a microporous layer on carbon paper.

One or more exemplary embodiments of the present teachings include a method of manufacturing the electrode, the method including: applying the water-repellent material to a surface of a gas diffusion layer, in a dot pattern; coating a catalyst slurry on the surface of the gas diffusion layer to which the water-repellent material is applied, to form a catalyst layer; and thermally treating the resultant.

The water-repellent material may be applied to the surface of the gas diffusion layer in a dot pattern. In this regard, each dot may have a diameter of from about 0.3 μm to about 300 μm, an x-directional interval between dots may be in a range of from about 0.3 mm to about 3 mm, and a y-directional interval between dots may be in a range of from about 0.3 mm to about 3 mm. The amount of the water-repellent material may be in a range of from about 0.01 to about 0.1 mg/cm², with respect to the gas diffusion layer.

Any suitable method may be used to apply the water-repellent material to the surface of the gas diffusion layer. Generally, the water-repellent material is applied such that, during the thermal treatment, the dots of the mater-repellent material do not substantially run together during melting, such that the discontinuous pattern of the water-repellent material is maintained. The water-repellent material may be dissolved in a solvent, or may be dispersed in a dispersive medium, to apply the water-repellent material in liquid or dispersion form to the surface of the gas diffusion layer. For example, a method of dotting using a dispenser, a method using a screen printer, a Decal method of stamping a water-repellent material having been applied to a template on the gas diffusion layer, or other various methods, may be used.

The water-repellent material is applied to the gas diffusion layer, is then dried to remove the solvent, and then a catalyst slurry is coated thereon, to form the catalyst layer. Then, the resultant structure is dried and thermally treated in a vacuum or an inert atmosphere. The thermal treatment may be performed at a temperature of from about 300 to about 400° C., for from about 10 to about 90 minutes. The thermal treatment may be performed such that dots of the water-repellent material do not substantially flow together and thereby form a continuous layer. In some aspects, the thermal treatment may be conducted for from about 1 to about 3 hours.

The catalyst slurry may be prepared by mixing a catalyst, a solvent, and optionally a binder, and then stirring the mixture. The water-repellent material is radially diffused on the gas diffusion layer through the thermal treatment, resulting in a concentration gradient being formed in each dot. The concentration of the water-repellent material continuously decreases from the gas diffusion layer, towards the catalyst layer. In addition, a discontinuous concentration gradient is formed in the surface direction of the gas diffusion layer.

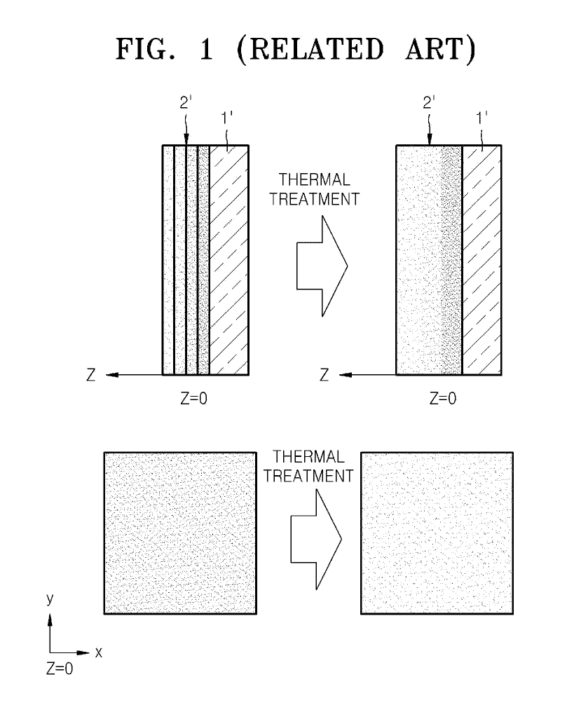

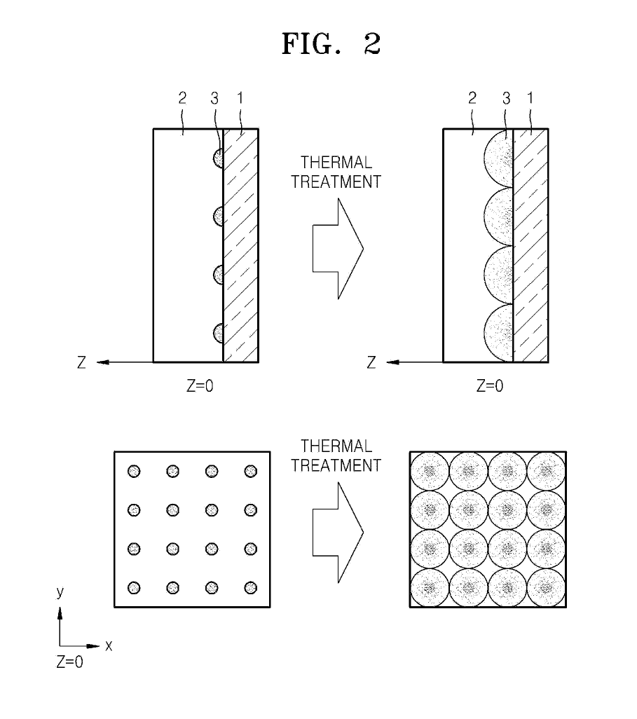

FIGS. 1 and 2 illustrate methods of manufacturing an electrode having a concentration gradient of a water-repellent material, according to the related art and an exemplary embodiment of the present teachings, respectively.

Referring to FIG. 1, catalyst slurries having different concentrations of a water repellent material are layered on a gas diffusion layer 1′, to form a catalyst layer 2′. Then, the resultant structure is thermally treated, so that the catalyst layer 2′ has a continuous concentration gradient in the thickness direction of the electrode. However, the catalyst layer 2′ has a uniform concentration, i.e., has no gradient, in the surface direction of the electrode.

Referring to FIG. 2, according to an exemplary embodiment of the present teachings, a water-repellent material 3 is applied to a surface of a gas diffusion layer 1, in a dot pattern, a catalyst layer 2 is formed thereon, and then the resultant is thermally treated. As a result, the catalyst layer 2 has a continuous concentration gradient in the thickness direction of the electrode and a discontinuous gradient in the surface direction of the electrode. Thus, the electrode has excellent gas diffusion and a high permeability to phosphoric acid.

One or more exemplary embodiments of the present teachings include an MEA including a cathode, an anode, and a polymer electrolyte membrane. At least one of the cathode and the anode is the electrode described above.

The polymer electrolyte membrane is not particularly limited, and may be at least one selected from the group consisting of polybenzimidazole (PBI), cross-linked polybenzimidazole, poly(2,5-benzimidazole) (ABPBI), polyurethane, and modified polytetrafluoroethylene (PTFE). The polymer electrolyte membrane may be impregnated with phosphoric acid or other acids. The concentration of the phosphoric acid may be in a range of about 80 to about 100 wt %. For example, an 85 wt % aqueous solution of phosphoric acid may be used.

One or more exemplary embodiments of the present teachings include a fuel cell (not shown) including the MEA. The fuel cell can have any suitable configuration, as would be apparent to one of skill in the art.

Hereinafter, one or more exemplary embodiments will be described in detail, with reference to the following examples. These examples are not intended to limit the scope of the present teachings.

### EXAMPLE 1

Manufacture of Cathode

0.2 g of a polytetrafluoroethylene (PTFE) dispersion (60 wt % in H₂O) was diluted with 6 g of isopropylalcohol (IPA). The resulting solution was uniformly dropped onto a polyethyleneterephthalate (PET) film having a thickness of 200 μm. The resultant patterned film was then dried at room temperature, for 10 minutes. The patterned film included projections (dots) of the PET, having a lower diameter of 50 μm and a height of from about 25 to about 27 μm, which were arranged at an interval of 50 μm, in both horizontal and longitudinal directions. The patterned film, which was half dried, was placed on a gas diffusion layer (SGL35BC) and stamped using a hand roller, to transfer the PTFE onto the gas diffusion layer (Decal method). The amount of the transferred PTFE was 0.02 mg/cm², based on the gas diffusion layer. The gas diffusion layer, onto which the PTFE was transferred, was dried on a 60° C. hot plate, for about 1 hour. 0.5 g of a PtCo/C cathode catalyst material (TEC36E52, available from Tanaka Precious Metals Co.), and 2 g of an N-methylpyrrolidone solvent (NMP), were put in a container and agitated using a high-speed agitator (AR-250), for 2 minutes. 0.25 g of a polyvinylidenefluoride (PVDF) solution (5 w % in NMP) was added to the mixture, and the resultant was agitated at room temperature, to prepare a catalyst slurry.

The catalyst slurry was coated on the gas diffusion layer, onto which the PVDF was transferred, using a doctor blade (with a gap of 530 μm from the substrate). The resultant structure was dried on a 60° C. hot plate, for about 1 hour, thermally treated at 120° C., for 1 hour, and then at 340° C. for 20 minutes, in a vacuum, and then cooled in a furnace to obtain a cathode. The loading amount of Pt in the cathode was about 1.22 mg/cm².

Manufacture of Anode

0.5 g of PtRu/C (TEC64E54, available from TKK) and 2.0 g of an NMP solvent were put in a container and stirred using a high-speed agitator (AR-250), for 2 minutes. 0.25 g of a 5% PVDF solution was added to the mixture, and the resultant was agitated for 2 minutes, to prepare a slurry.

The slurry was coated on carbon paper (SGL35BC) cut to a size of 7×4cm², using bar coating (#80), and then dried to remove the solvent. The drying was performed at room temperature, for 1 hour, and then in an oven at 80° C., for 30 minutes, at 120° C. for 30 minutes, and at 150° C. for 10 minutes. The drying was followed by cooling in a furnace. The loading amount of Pt in the anode was about 0.9 mg/cm².

Manufacture of MEA

An MEA was assembled using the cathode, the anode, and phosphoric acid-impregnated polybenzoxazine polymer electrolyte membrane. The MEA was assembled by cutting each of the cathode and the anode into 3.1 cm squares, disposing the polymer electrolyte membrane between the cathode and the anode, and binding the assembly with a torque of 3 Nm.

### EXAMPLE 2

A PTFE dispersion (20 wt % in NMP) was applied to the surface of the gas diffusion layer, using a dispenser (JETMASTER 2, available from Musashi Engineering Inc.). The volume of droplets ejected from the dispenser was 10 nl, and droplets of the PTFE dispersion were spotted at an interval of 2.6 mm in the horizontal direction, and an interval of 1.8 mm in the longitudinal direction (0.065 mg/cm² with respect to the gas diffusion layer). The gas diffusion layer, to which the water-repellent material was applied, was dried at room temperature, for 1 hour, and further dried in an oven at 120° C., for 1 hour or longer. Then, an MEA was manufactured in the same manner as in Example 1.

### Example 3

A PTFE dispersion (20 wt % in NMP) was applied to the surface of the gas diffusion layer, using a dispenser (JETMASTER 2, available from Musashi Engineering Inc.). The volume of droplets ejected from the dispenser was 10 nl, and droplets of the PTFE dispersion were spotted at an interval of 3.0 mm in the horizontal direction and an interval of 2.0 mm in the longitudinal direction (0.05 mg/cm² with respect to the gas diffusion layer). The gas diffusion layer, to which the water-repellent material was applied, was dried at room temperature, for 1 hour, and further dried in an oven at 120° C., for 1 hour or longer. Then, an MEA was prepared in the same manner as in Example 1.

### COMPARATIVE EXAMPLE 1

A MEA was manufactured in the same manner as in Example 1, except that the water-repellent dispersion of PTFE of Example 1 was sprayed onto the gas diffusion layer using a spray gun, at a pressure of 20 psi, and dried on a 60° C. hot plate for 1 hour or longer, in order to manufacture a cathode.

### COMPARATIVE EXAMPLE 2

A MEA was manufactured in the same manner as in Example 1, except that the cathode catalyst slurry of Example 1 was coated on an untreated gas diffusion layer, using bar coating (#100), and then the resultant was dried at 80° C., for 1 hour, at 120° C. for 30 minutes, and at 150° C. for 10 minutes, in order to manufacture a cathode.

Performance Evaluation Method

The performance of the MEAs manufactured in Examples 1, 2, and 3 and Comparative Examples 1 and 2 was evaluated under a 150° C., non-humidified condition, while supplying air to the cathode at a rate of 250 cc per minute and while supplying hydrogen to the anode at a rate of 100 cc per minute at 150° C. An actual reaction area of the electrodes was fixed to 2.8×2.8cm². I-V curves were obtained, by measuring variations in potential while increasing a current level.

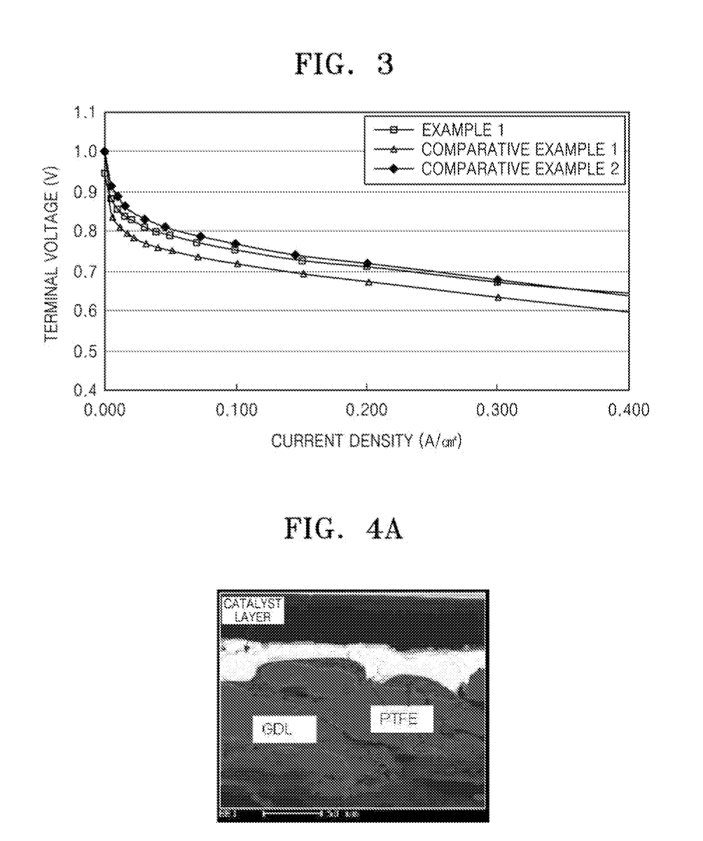

The performance results of the MEAs of Examples 1, 2, and 3 and Comparative Examples 1 and 2 are shown in Table 1 below and FIG. 3. In the performance test, the MEA of Comparative Example 2 was used as a reference. FIG. 3 is a graph of voltage with respect to current density, of the MEAs according to Example 1 and Comparative Examples 1 and 2.

TABLE 1

| | | | | Compar- | |
|---|---|---|---|---|---|
| | Exam- | Exam- | Exam- | ative | Comparative |
| | ple 1 | ple 2 | ple 3 | Example 1 | Example 2 |
| Loading amount | 1.22 | 1.5436 | 1.433 | 1.27 | 1.70 |
| of Pt (mg/cm²) | | | | | |
| Terminal voltage | 0.678 | 0.680 | 0.686 | 0.6346 | 0.673 |
| (V@0.3 A/cm²) | | | | | |

As shown in Table 1 and FIG. 3, the MEA of Example 1 had a voltage of 0.3 A/cm², which was equivalent to the MEA of Comparative Example 2, and which was produced using only ⅔ of the loading amount of Pt as compared to the MEA of Comparative Example 2. For the MEA of Comparative Example 1, a thin PTFE film is present between the catalyst layer and the gas diffusion layer, which increases resistance. As a result, the performance of the MEA was degraded, due to an increase in IR drop and a decrease in gas permeability.

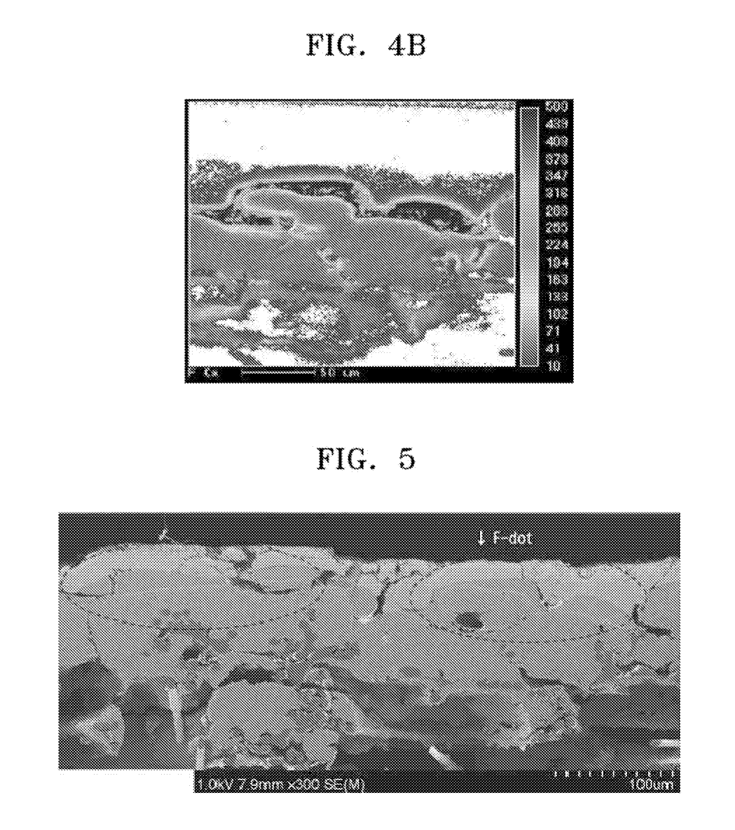

FIGS. 4A and 4B are a SEM image and an electron probe microanalytic (EPMA) image of the MEA according to Example 2, respectively. FIG. 5 is a SEM image of a larger cross-section of the MEA than of FIG. 4A. As is apparent from FIGS. 4A, 4B, and 5, PEFE dots are diffused from the gas diffusion layer (GDL) toward the catalyst layer. However, adjacent PEFE dots are discontinuous, which prevents a problem of insulation, which would occur if such a water-repellent material fully covers the gas diffusion layer.

As described above, according to the one or more of the above exemplary embodiments, an electrode having a concentration gradient of a water-repellent material may be manufactured through a simple process, and the electrode has an equivalent performance as common electrodes, while using a smaller loading amount of Pt. Thus, costs of manufacturing fuel cells may be reduced.

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

What is claimed is:

1. A fuel cell electrode comprising:
a gas diffusion layer;
a catalyst layer; and
a water-repellent material disposed at an interface between the gas diffusion layer and the catalyst layer, having a continuous concentration gradient in a first direction extending away from the gas diffusion layer, and a discontinuous concentration gradient in a second direction generally perpendicular to the first direction.

2. The electrode of claim 1, wherein the amount of the water-repellent material is in a range of from about 0.01 mg/cm² to about 0.1 mg/cm², with respect to the gas diffusion layer.

3. The electrode of claim 1, wherein the concentration of the water-repellent material in the first direction continuously decreases from the gas diffusion layer toward the catalyst layer.

4. The electrode of claim 1, wherein the water-repellent material comprises a hydrophobic polymer.

5. The electrode of claim 4, wherein the hydrophobic polymer comprises polytetrafluoroethylene (PTFE), fluorinated ethylene propylene (FEP), or a perfluoroalkoxy (PFA).

6. A method of manufacturing a fuel cell electrode, comprising:
applying a water-repellent material to a first surface of a gas diffusion layer, in a dot pattern;
coating a catalyst slurry on the first surface of the gas diffusion layer and the water-repellant material, to form a catalyst layer; and
thermally treating the resultant.

7. The method of claim 6, wherein the water-repellent material is applied in a dot pattern, with each dot having a diameter of from about 0.3 μm to about 300 μm.

8. The method of claim 6, wherein the amount of the water-repellent material is in a range of from about 0.01 mg/cm² to about 0.1 mg/cm², with respect to the gas diffusion layer.

9. The method of claim 6, wherein the water-repellent material is applied using a micro-dispenser, a screen printer, or a template.

10. The method of claim 6, wherein the thermally treating is performed at a temperature of from about 300 to about 400° C., for from about 10 to about 90 minutes.

11. A fuel cell membrane-electrode assembly comprising:
a cathode;
an anode; and
a polymer electrolyte membrane,
wherein at least one of the cathode and the anode is the electrode according to claim 1.

12. A fuel cell comprising the membrane-electrode assembly of claim 11.

13. A fuel cell membrane-electrode assembly comprising:
a cathode;
an anode; and
a polymer electrolyte membrane,
wherein at least one of the cathode and the anode is the electrode according to claim 2.

14. A fuel cell comprising the membrane-electrode assembly of claim 13.

15. A fuel cell membrane-electrode assembly comprising:
a cathode;
an anode; and
a polymer electrolyte membrane,
wherein at least one of the cathode and the anode is the electrode according to claim 3.

16. A fuel cell comprising the membrane-electrode assembly of claim 15.

17. A fuel cell membrane-electrode assembly comprising:
a cathode;
an anode; and
a polymer electrolyte membrane,
wherein at least one of the cathode and the anode is the electrode according to claim 4.

18. A fuel cell comprising the membrane-electrode assembly of claim 17.

19. A fuel cell membrane-electrode assembly comprising:
a cathode;
an anode; and
a polymer electrolyte membrane,
wherein at least one of the cathode and the anode is the electrode according to claim 5.

20. A fuel cell comprising the membrane-electrode assembly of claim 19.
